(19) United States
(12) Patent Application Publication
(10) Pub. No.: US 2006/0164383 A1
(43) Pub. Date: Jul. 27, 2006

(54) Remote controller ring for user interaction

(75) Inventors: Alberto Perdomo Machin, Gran Canaria (ES); Rebecca Allen, Los Angeles, CA (US)

Correspondence Address: CHARLES G. CALL, 68 HORSE POND ROAD, WEST YARMOUTH, MA, 02673-2516, US

(73) Assignee: Media Lab Europe (in Voluntary Liquidation), Dublin 2 (IE)

(21) Appl. No.: 11/303,041

(22) Filed: Dec. 15, 2005

Related U.S. Application Data
(60) Provisional application No. 60/636,601, filed on Dec. 16, 2004.

(51) Int. Cl. G09G 5/00

(52) U.S. Cl. 345/156

(57) ABSTRACT

A hand-worn controller consisting of a housing having a central opening sized to permit the controller to be worn as ring on the index finger of a human hand. A joystick lever projects outwardly from said housing and is positioned to be manipulated by the user's thumb. The joystick operates on or more control devices, such as switches or potentiometers, that produce control signals. A wireless communications device, such as a Bluetooth module, mounted in said housing transmits command signals to a remote utilization device which are indicative of the motion or position of said joystick lever.

### CROSS REFERENCE TO RELATED APPLICATIONS

This application is claims the benefit of the filing date of U.S. Provisional Patent Application Ser. No. 60/636,601 filed on Dec. 16, 2005, the disclosure of which is incorporated herein be reference.

### FIELD OF THE INVENTION

This invention relates to remote controllers for controlling the operation of nearby electronic devices using a short range wireless communication link.

### BACKGROUND OF THE INVENTION

Traditional human computer interfaces require high attention for their operation and reduce the user's freedom of movement and ability to perform other tasks simultaneously. The user usually sits in front of her laptop or desktop computer looking at the screen and holding her hands on the keyboard and mouse to interact with the device. Other “mobile” appliances such as PDAs and mobile phones require the user to hold them in one hand while the interaction is happening. The input mechanism in this case is typically a pen in conjunction with a touch screen, a joystick and/or a number of buttons. In both cases user interaction results in distraction from the current task, generating a high attention load and having at least one if not both hands occupied. Considering that such devices are usually transported in clothing pockets or bags, it means that the user has first to retrieve the device, then use one or two of her hands in order to interact with it and then place it again in its original place.

A partial solution to the problems mentioned can be found in systems that deliver output in hands-free form using audio, haptic signaling, or graphics displays such as projections onto windshields or graphic displays embedded in eyeglasses. However appropriate input mechanisms are still a challenge.

For devices such as mobile phones, solutions integrating headsets and voice recognition are available on the market. The user speaks aloud specific words to trigger the associated commands. This can be particularly annoying for surrounding people and can even be impracticable in some situations where silence should be kept. The system may also be unusable in noisy environments. Burton Snowboards North America, Burlington, Vt., USA, and Apple Computer, Inc, Cupertino, Calif., USA, addressed the challenge by developing a wearable snowboarding jacket with an integrated control system for the Apple iPod. This is a good approach, although it requires the user to wear the jacket to interact with the device, thus restricting the everyday usability.

Devices that can be worn on the hand like a ring have been used in a limited number of applications.

Researchers from NIT Human Interface Laboratories have developed ring shaped sensors embedding accelerometers to sense finger typing on surfaces. The signals are transmitted to a wrist watch device using the body as part of an electrical circuit. A special symbol coding is proposed that combines order and chord typing. See: Fukumoto, M., Tonomura, Y.: “Body Coupled FingerRing”: Wireless Wearable Keyboard. In: Proceedings of the SIGCHI conference on Human factors in computing systems, Atlanta, Ga., 1997.

The Bio Robotics Research Laboratory at M.I.T., Harry Asada and Phillip Shaltis developed the “Ring sensor,” a wireless, noninvasive, continuous health monitoring device in the shape of a ring that acquires phyisiological signals and transmits them to a base station where these are processed. See http://darbelofflab.mit.edu/ring_sensor/ring_sensor.htm.

The Active Vision Group at Oxford developed the “WearClam,” a small keyboard with 9 buttons that is attached to the index ring and can be used for typing using the thumb. See http://www.robots.ox.ac.uk/˜wmayol/wearclam/.

### SUMMARY OF THE INVENTION

The following summary provides a simplified introduction to some aspects of the invention as a prelude to the more detailed description that is presented later, but is not intended to define nor delineate the scope of the invention.

The present invention takes the form of a remote controller housed in or supported by in a ring worn by the user on one of her fingers. By manipulating the ring the user can control a remote device that is connected to the ring. Whenever the ring detects user interaction it sends a command over the connection to the remote device according to a specific mapping. The ring can be used to interact remotely with devices such as Personal Digital Assistants (PDAs), mobile phones, smart phones, laptops, personal computers, television sets, or other electronic device capable of being remotely controlled.

In its preferred embodiment, the invention takes the form of a hand-worn controller consisting of an housing having a central opening sized to permit the controller to be worn as a ring on the index finger of a human hand. A joystick lever projects outwardly from the housing and is positioned to be manipulated by the user's thumb. The joystick operates one or more control devices, such as switches or potentiometers, that produce control signals. A wireless communications device, such as a Bluetooth module, mounted in the housing transmits command signals to a remote utilization device which are indicative of the motion or position of the joystick lever.

Using the ring, the user is able to interact with her devices in a spontaneous way. The ring allows the user to focus on her main task, interact with the device when needed and switch back to her original task without having to retrieve the device or hold it in her hand, and thus minimizing the disruption of the main task (e.g. the person can carry a PDA in her bag and interact with it using the ring).

### BRIEF DESCRIPTION OF THE DRAWINGS

In the detailed description which follows, frequent reference will be made to the attached drawngs, in which:

FIG. 1 is a perspective view illustrating an embodiment of the invention worn on the user's hand;

FIG. 2 is side elevational view of the controller ring; and

FIG. 3 is a block diagram of the principle electronic components housed in the controller ring.

### DETAILED DESCRIPTION

The preferred embodiment of the invention is housed in an annular ring 10 which slips over and is worn on the index finger (also called the “demonstatorius” or “pointer finger”) 12 of either hand. A joystick lever 14 extends outwardly from the ring housing and is naturally positioned to be easily manipulated by the user's thumb 16.

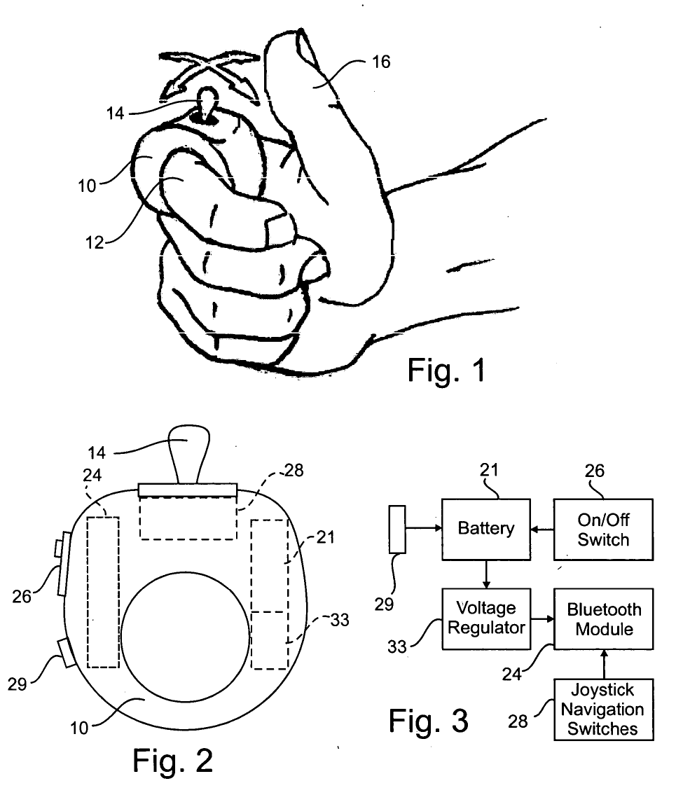

As seen in FIGS. 2 and 3, the ring housing 10 encloses a power supply consisting of a battery 21 and a voltage regulator 33, and a Bluetooth communication module 24 which provides a wireless Bluetooth connection to the remote device. An On-Off switch 26 and a mini-thumb-joystick lever 14 than operates navigation switches 28. The lever 14 extends outwardly from the exterior of the ring housing where it is directly under and readily movable by the user's thumb as seen in FIG. 1.

The battery 21 is preferably a lithium polymer rechargeable battery that can be recharged by connecting the device to an external battery charger using the recharging socket 29. The controller ring communicates with an external device via a communications link that conforms to the Bluetooth standard, chosen in part because it enjoys wide spread use across the consumer market and is currently integrated in a wide variety of devices, such as television sets, PDAs, mobile telephones, personal computers, etc.

The joystick operated navigation switches 28 may be implemented using the subminature navigation switch model TPA Series Subminiature Tact Switch available from ITT Industries Cannon, Inc., White Plains, N.Y., USA. The switch 28 provides 5 way switching (four orthagonal directions and also a “select” function actuated by pressing downwardly on the joystick. The switch provides a distinctive tactile feel for directional scanning and and select functions. The joystick lever 14 may be pressed downwardly to make a selection in any position by closing the fifth switching connection.

The Bluetooth module 24 may be implemented using the WML-C19ABN class 2 programmable module available from Mitsumi Electric Co., Ltd., Tokyo, Japan. The bluetooth module is powered using a Lithium Polymer rechargeable battery 21, which may be a UBC641730 battery available from Ultralife Batteries, Inc., Newark, N.Y., USA. The voltage regulator 33 may be implemented using the MAX8882EUTA5 from Maxim Integrated Products, Inc., Sunnyvale, Calif., USA which is capable of supplying the Bluetooth module 24 with voltages of 3.3V and 1.8V.

The Specification of the Bluetooth System, Version 2.0 (2004) available at https://www.bluetooth.org/spec describes the details of the Bluetooth protocol. In addition, the HUMAN INTERFACE DEVICE (HID) PROFILE VERSION 1.0 defines how devices capable of Bluetooth™ wireless communications can use the HID Protocol initially to discover the feature set of a human interface device (HID), and then communicate with the HID. A HID (Human Interface Device) is the device providing the service of human data input and output to and from the host. Because the USB specification's definition of HID includes all devices that report data in a similar fashion to HIDs. Examples of HIDs are mice, joysticks, gamepads, keyboards, and also voltmeters and temperature sensors. The HID is normally the slave in the Bluetooth piconet structure. The host is the device using or requesting the services of a Human Interface Device. Examples would be a personal computer, handheld computer, gaming console, industrial machine, or data-recording device. The host is normally the master in the Bluetooth piconet structure. Thus, a ring controller contemplated by the present invention may be advantageously implemented as a Bluetooth Human Interface Device conforming to the HID Profile, and in that way perform the functions provided by other kinds of peripheral controllers, such as mice, joysticks and gamepads.

The navigation switches 28 may be directly connected to input/output pins the Bluetooth module. The common terminals (pins 1 and 2) of the switches are connected to a pull-up resistor. The other pins are connected to input/output pins of the Bluetooth chip. The software which resides on and is executed by the Bluetooth chip handles the Bluetooth connections to the other devices and all the needed communication functions. Additional programmed functions include: detecting the activation of the joystick and sending a command to the remote system according to a specific mapping. The I/O pins on the Bluetooth module connected to the navigation switch terminals are set to a weak low level (using the internal weak pull-downs). Whenever the switch is pressed in one or more of the directions (up, down, left, right, select), the corresponding line voltages change from a logic low to a logic high level by the effect of the pull-up resistor. The Bluetooth chip is programmed to detect these voltage level changes on the I/O pins. Whenever a rising edge on one of the lines is detected, the software interprets that transition. For example, a rising edge on the chip terminal connected to the “up” switch terminal on the navigation switch means that the joystick lever 14 was manipulated in ‘UP’ direction, and the Bluetooth module accordingly translates that motion into a specific command that is sent over the Bluetooth connection to the remote device which interprets the command in a appropriate way (e.g. an AT command to finish a phone call, or a command to move up one position on a menu displayed by a remotely located device controlled by the ring).

Instead of transmitting ON-OFF signals, the joystick lever may be coupled to potentiometers that produce signals having continuously variable amplitudes indicative of the current position of the joystick. These signals may be digitized and transmitted by the Bluetooth link to provide a continuous indication of the joystick position.

The controller ring of the type described may be used in a rich variety of applications, as illustrated by the following examples:

The ring may be used in combination with a menu display visible to a user wherein the directional navigation switches may be used to move a “cursor” (a pointer or a moving highlight) to a particular option, and then pressing the joystick downward to select that option. Control menus of that kind are commonly used on conventional devices, such as program guides for audio players and television sets, and on cellular phones. Audio devices may provide audible prompts to the user which announce available options; for example, the user may use the navigational controller to select from a nested list of options delivered in the same fashion options are presented to callers by some telephone stationsets and cellular handsets.

Alternatively, the ring controller may be used in combination with devices whose mode of operation is varied in ways that is perceptible to the user. For example, the joystick may be moved up or down to control the audio volume of an audio player or a television set, while right and left motion may be used to switch channels or skip from song to song, forward or backwards. A radio controlled toy can be steered from left to right by moving the joystick lever from left to right, while the speed of the toy can be controlled by moving the joystick lever forward and backward. In each of these examples, the perceived behavior of the controlled device itself provides the information the user needs in manipulating the ring control to achieve a desired result. Audio devices controlled by the ring controller may create an audio stream that is presented to the user through headphones or speakers (e.g. the items in the current menus are transmitted to the user by associating them to different words that are spoken to the user, ‘New SMS’, ‘Incoming SMS’, etc.). These audio and visual prompts may allow navigation through nested menus.

The ring may include a built-in haptic device (such as a miniature loadspeaker in contact with the user's finger) which is actuated by a signal received from a remote device via the Bluetooth connection. In this way, the user may receive haptic feedback whose character and intensity provides the user with an indiction of the effect achieved when the joystick is manipulated.

By way of example, the controller ring may be used in combination with haptic feedback to increasing the level of interactivity in interactive TV. U.S. patent application Ser. No. 11/096,715 filed on Apr. 1, 2005 entitled “System for creating, broadcasting and reproducing haptic and audiovisual program content” describes a system invented by O'Modhrain et al. utilizes the sense of touch to engage the user of a control device, such as a television remote control, to increase viewer's perceived sense of engagement in the controlled environment. In one arrangement disclosed in the above-noted application, the haptic transducers which convey touch stimuli to the human observer preferably take the form of a force feedback device such as a joystick or stylus which forms part of a hand-held remote control unit. The hand-worn ring controller contemplated by the present invention may be used to advantage to implement a haptic control interface of the kind described in the O'Modhrain et el. application, the disclosure of which is incorporated herein by reference.

A visual indicator, such as one or more LED devices, may also be built into the ring to provide visual feedback to the user. Thus, for example, an LED (not shown) may be illuminated when the ring controller has established a communication link with a remote device, or when the controlled device assumes a particular state.

### CONCLUSION

It is to be understood that the methods and apparatus which have been described above are merely illustrative applications of the principles of the invention. Numerous modifications may be made by those skilled in the are without departing from the true spirit and scope of the invention.

What is claimed is:

1. A hand worn controller for transmitting command signals to control a remotely located electronic device comprising, in combination,
a ring worn on the finger of a user;
a manually manipulatable control device housed in or supported by said ring,
a wireless communication device housed in or supported by said ring, said communications device being connected to transmit said command signals to said remotely located electronic device in response to the manipulation of said control device.

2. A hand worn controller as set forth in claim 1 wherein said control device is positioned on said ring to that it can be readily manipulated by the user's thumb when the ring is worn on the user's index finger.

3. A hand worn controller as set forth in claim 2 wherein said manually manipulatable control device is a joystick having a lever which can be moved in at least two different directions by said user.

4. A hand worn controller as set forth in claim 3 wherein said lever operates a plurality of switches whose switched state is communicated via said wireless controller to said remotely located device.

5. A hand worn controller as set forth in claim 4 wherein said wireless communications transmits said command signals using the Bluetooth protocol and wherein said remotely located electronic device includes a Bluetooth receiver for receiving said command signals from said hand worn controller.

6. A hand worn controller as set forth in claim 5 wherein said hand worn controller further includes an output device for producing a output indication perceptible to said user in response to a notification signal transmitted from said remotely located electronic device using the Bluetooth protocol.

7. A hand worn controller as set forth in claim 1 wherein said wireless communications device transmits said command signals using the Bluetooth protocol and wherein said remotely located electronic device includes a Bluetooth receiver for receiving said command signals from said hand worn controller.

8. A hand worn controller as set forth in claim 1 wherein said hand worn controller further includes an output device for producing a output indication perceptible to said user.

9. A hand worn controller as set forth in claim 8 wherein said output indication is a vibratory signal which can be haptically perceived by said user.

10. A hand worn controller as set forth in claim 8 wherein said output device is a visual indicator for producing a visible display perceptible to said user.

11. A hand worn controller as set forth in claim 10 wherein said manually manipulatable control device includes at least one electrical switch which is turned on and off by said user.

12. A hand worn controller as set forth in claim 8 wherein said output device is connected to said communication device for producing said output indication in response to a notification signal sent from said remotely located electronic device.

13. A hand-worn controller comprising:
an annular housing having a central opening sized to be worn on the index finger of a human user,
a joystick lever attached to said housing and projecting outwardly from said housing and positioned to be manipulated by the user's thumb,
one or more control devices actuated by the movement of said lever,
a wireless communications device mounted in said housing and connected to said one or more control devices to transmit command signals to a remote utilization device indicative of the motion or position of said joystick lever.

14. A hand-worn controller as set forth in claim 13 wherein at least one of said control devices is an electrical switch which is turned on and off by the motion of said lever.

15. A hand-worn controller as set forth in claim 14 wherein said wireless communications device transmits said command signals using the Bluetooth protocol and wherein said remote utilization device includes a Bluetooth receiver for receiving said command signals from said hand worn controller.

16. A hand-worn controller as set forth in claim 13 wherein said control devices comprise of plurality of electrical switches which are turned on and off by the motion of said lever.

17. A hand-worn controller as set forth in claim 13 wherein said wireless communications device transmits said command signals using the Bluetooth protocol and wherein said remote utilization device includes a Bluetooth receiver for receiving said command signals from said hand worn controller.

18. A hand-worn controller as set forth in claim 13 wherein said hand-worn controller further includes an output device for producing a output indication perceptible to said human user in response to a notification signal transmitted to said hand-worn controller from said remote utilization device.
